(19) United States
(12) Patent Application Publication
(10) Pub. No.: US 2015/0035756 A1
(43) Pub. Date: Feb. 5, 2015

(54) KEYPAD DEVICE FOR A TOUCH SCREEN AND METHOD FOR PROVIDING SAME

(71) Applicant: MOBIENCE, INC., Seongnam-si (KR)

(72) Inventor: Jaewoo Ahn, Seongnam-si (KR)

(21) Appl. No.: 14/358,786

(22) PCT Filed: Nov. 9, 2012
(86) PCT No.: PCT/KR2012/009432

§ 371 Date: Sep. 29, 2014

(30) Foreign Application Priority Data
Nov. 16, 2011 (KR) 10-2011-0119308
Nov. 6, 2012 (KR) 10-2012-0124871

(51) Int. Cl. G06F 3/02; G06F 3/023

(52) U.S. Cl. CPC G06F 3/0219; G06F 3/023
USPC 345/169

(57) ABSTRACT

A keypad apparatus for a touch screen and to a method for providing same. The key pad apparatus includes a plurality of buttons, a storage device, a processor, and a communication module included in the plurality of buttons and outputting, to the touch screen, a selection output signal selected from among a plurality of output signals corresponding to respective letters when a letter button to which a letter is allocated is selected. The processor selects the selection output signal from among the plurality of output signals on the basis of state information stored in the storage device, and controls the output of the selected selection output signal.

### TECHNICAL FIELD

The present invention relates to a keypad device for a touchscreen device and a method of providing the same, and more particularly, to a keypad device which is provided separately from a touchscreen device in order to control the touchscreen device and which is easy to carry and learn, and a method of providing the same.

### BACKGROUND ART

Recently, touchscreen devices, i.e. devices in which a touchscreen scheme is adopted, have become widely distributed in accordance with the development of touchpads. Such touchscreen devices are being actively utilized in devices in some fields such as mobile telecommunications (so-called smartphones) or tablet personal computers (PCs).

While some devices from among these touchscreen devices are equipped with a physical keypad, other touchscreen devices have no physical keypad.

Touchscreen devices without a physical keypad allow users to input letters or a variety of control signals using a soft keypad, i.e. an input interface realized by software. In this case, since no physical keypad is provided, it is advantageous for users to be able to use a screen, the area of which is increased as large as a physical keypad.

However, there is a drawback in that users are required to input letters or control signals into touchscreen devices while looking at the input interface being displayed on the touchscreen. This drawback of having to look at the touchscreen is somewhat inconvenient, even for visually unimpaired persons, and this drawback makes it particularly difficult for visually impaired persons to use touchscreen devices.

Therefore, it is still necessary for touchscreen devices to be equipped with separate physical keypad devices (or keyboards) by which letters as well as control signals can be input into touchscreen devices.

In addition, even in the case that touchscreen devices are equipped with physical keypads, in addition to such physical keypads equipped in touchscreen devices, there still exists the necessity for separate physical keypad devices that are independent of touchscreen devices. This is due to the fact that it still remains difficult to control one touchscreen device using a keypad provided on another touchscreen device, since touchscreen devices may be equipped with different types of keypad. Furthermore, it may be difficult to control touchscreen devices without the means of a physical keypad, and visually impaired persons may not be able to control touchscreen devices without a physical keypad.

Therefore, users may need a separate physical keypad device with which users can control touchscreen devices, regardless of whether or not touchscreen devices are already equipped with a physical keypad device.

When the keypad device is a full keyboard, i.e. a keyboard (e.g. a qwerty keyboard) that has a number of keys greater than the number of letters of a specific language (e.g. English), it may be easy to input letters. However, such keypad devices have poor portability, which is problematic. In addition, since full keyboards are designed in consideration of the simple letter-input without consideration of commands other than simple letter-input and a variety of additional functions, such as the navigation of items (or icons) displayed on the screen or web browsing, full keyboards are not suitable for such complicated and varied commands and functions. In addition, it is not easy for users to learn to control touchscreen devices using a keyboard, since a number of keys thereof are not systematically classified.

### DISCLOSURE

### Technical Problem

It is therefore an object of the invention to provide a keypad device for controlling a touchscreen device and a method of providing the same, in which the touchscreen device allows letters or a variety of commands to be input using a reduced number of buttons (keys) and has superior usability since it can be used intuitively and operations thereof are easy to learn.

Also provided are a keypad device and a method of providing the same, in which the touchscreen device provides a letter input scheme using a reduced number of buttons. The letter input scheme can be used universally without being dependent on a type of touchscreen device even in the case that a plurality of letters are allocated to a single button.

Also provided are a keypad device and a method of providing the same, in which an intended letter can be directly input without several selections, even in the case that a plurality of letters or symbols are allocated to a single button according to a plurality of languages.

Also provided are a keypad device and a method of providing the same, in which a preset mode can be selected with a single action, regardless of the present mode, from among a plurality of modes provided for each of a plurality of languages, numerals, symbols or commands.

Also provided are a keypad device and a method of providing the same, in which the keypad device can be easily used by a visually impaired person having difficulty in visually recognizing a touchscreen device or a person who is not paying careful attention to the touchscreen device, even in the case that he/she can recognize the touchscreen device.

### Technical Solution

According to an embodiment of the invention for realizing the concept of the invention, provided is a keypad device which is provided separately from a touchscreen device to control the touchscreen device. The keypad device includes: a plurality of buttons; a memory; a processor; and a communications module. When a letter button to which the plurality of letters are allocated is selected from among the plurality of buttons, the communications module outputs an output signal selected from among a plurality of output signals to the touchscreen device, the plurality of output signals respectively corresponding to a plurality of letters. The processor selects the selected output signal from among plurality of output signals based on state information stored in the memory and controls the selected output signal to be output.

The state information may include information on a previous letter corresponding to a previous output signal that is output in response to a previous button being selected just before the letter button is selected.

When the previous letter corresponding to the previous output signal is allocated to the letter button, the processor may control the selected output signal to be output. The selected output signal may include a delete signal with which the previous letter is deleted and a signal corresponding to a letter from among the plurality of letters that is to be input after the previous letter.

The plurality of buttons may include at least n−1 number of direct input function buttons when an n number of letters are allocated to the letter button, where n is a natural number equal to or greater than 2. When the letter button is selected in a state that one direct input function button from among the n−1 number of direct input function buttons is selected, the processor may control an output signal corresponding to a letter selected from among the n number of letters, the selected letter corresponding to the direct input function button, to be output regardless of a previously-selected button.

The plurality of buttons may be arranged in an a×b matrix, where each of the a and the b is a natural number equal to or greater than 2. The n−1 number of direct input function buttons may be sequentially arranged on an edge column or row of the a×b matrix, corresponding to an input sequence of the n number of letters.

The state information may further include information on a current mode from among a plurality of modes that the keypad device provides. The plurality of buttons may include: at least one mode switch button which switches the keypad device from a current mode to another mode; and at least one mode designation button which switches the keypad device to a predetermined mode regardless of the current mode when selected.

The plurality of buttons may be arranged in an a×b matrix, where each of the a and the b is a natural number equal to or greater than 2, and all or part of the at least one mode designation button is arranged at a position corresponding to a corner of the a×b matrix.

According to an embodiment of the invention for realizing the concept of the invention, provided is a keypad device provided separately from a touchscreen device to control the touchscreen device. The keypad device includes: a plurality of buttons; a processor; and a communications module, wherein the communications module outputs an output signal corresponding to a button selected from among the plurality of buttons to the touchscreen device. The plurality of buttons includes a letter button to which an n number of letters are allocated, where n is a natural number equal to or greater than 2, and at least n−1 number of direct input function buttons. When the letter button is selected in a case that one direct input function button from among the n−1 number of direct input function buttons is selected, the processor controls an output signal corresponding to a letter corresponding to the direct input function button selected from among the n−1 number of direct input function buttons to be output regardless of a previously-selected button.

According to an embodiment of the invention for realizing the concept of the invention, provided is a keypad device provided separately from a touchscreen device to control the touchscreen device. The keypad device includes: a plurality of buttons; a memory; a processor; and a communications module. The communications module outputs an output signal corresponding to a button selected from among the plurality of buttons to the touchscreen device. The memory stores information on a current mode of the keypad device. The plurality of buttons includes: at least one mode switch button which switches the keypad device from a current mode to another mode; and at least one mode designation button which switches the keypad device to a predetermined mode regardless of the current when selected.

In order to realize the object of the invention, provided is a method of providing a keypad device separately from a touchscreen device to control the touchscreen device. The method includes the following steps of: when a letter button to which a plurality of letters are allocated is selected from among a plurality of buttons on the keypad device, selecting, at the keypad device, an output signal from among a plurality of output signals respectively corresponding to the plurality of letters, based on state information stored in the keypad device; and outputting, at the keypad device, the selected output signal to the touchscreen device.

The selected output signal may include a delete signal with which a previous letter corresponding to previous output signal is deleted and a signal corresponding to a letter from among the plurality of letters that is to be input after the previous letter.

The method may include the step of: when the letter button on the keypad device is selected in a state that a direct input function button provided on the keypad device is selected, outputting, at the keypad device, an output signal corresponding to a letter from among plurarity of letters that corresponds to the direct input function button, regardless of a letter corresponding to a previously-selected button.

The method may include the step of: when a mode designation button is selected from among the plurality of buttons on the keypad device, switching, at the keypad device, to a predetermined mode regardless of a current mode of the keypad device.

According to an embodiment of the invention for realizing the concept of the invention, provided is a method of providing a keypad device separately from a touchscreen device to control the touchscreen device. The method includes the following step of: in a state one direct input function button is selected from among at least n−1 number of direct input function buttons on the keypad device, when a letter button to which an n number of letters are allocated is selected, where n is a natural number equal to or greater than 2, outputting, at the keypad device, an output signal corresponding to a letter selected from among the n number of letters, the selected letter corresponding to the direct input function button, regardless of a previously-selected button.

According to an embodiment of the invention for realizing the concept of the invention, provided is a method of providing a keypad device separately from a touchscreen device to control the touchscreen device. The method includes the following steps of: storing, at the keypad device, information on a current mode of the keypad device; and switching, at the keypad device, from the current mode to another mode by a predetermined sequence when a mode switch button is selected and to a predetermined mode regardless of the current mode when a mode designation button is selected.

The method of providing a keypad device for a touchscreen device may be stored in a computer readable recording medium in which a program is recorded.

### Advantageous Effects

According to the keypad for a touchscreen device and the method of providing the same according to the concept of the invention, even in the case that a plurality of letters are allocated to a single button since a reduced number of buttons is used, the keypad device itself can determine an output signal to be output to the touchscreen device according to a selected button and subsequently output the determined output signal to the touchscreen device. Accordingly, it is possible to provide a universal letter input scheme independent of a type of touchscreen device.

In addition, even in the case that a plurality of letters or signals are allocated to a single button according to a plurality of languages, an intended letter can be directly input without several selections, thereby reducing the time taken to input the letter and the number of selections required for the letter.

Furthermore, when a plurality of modes is provided for each of a plurality of languages, numerals, symbols or commands, a preset mode can be selected with a single action regardless of the present mode. Accordingly, a person unable to visually recognize the present mode can directly enter the intended mode, or it is possible to directly enter the intended mode in a state in which the present mode is visually unrecognizable.

In particular, due to this effect, the keypad device can be easily used by visually impaired persons having difficulty in visually recognizing a touchscreen device or a person who is not paying careful attention to looking at the touchscreen device even in the case that he/she can recognize the touchscreen device.

In addition, although the number of buttons is reduced, the buttons are systematically arranged such that letters or a variety of commands can be input in an intuitive fashion, thereby making operations easy to learn.

### DESCRIPTION OF DRAWINGS

The concept of the present invention will be more apparent from the following description taken in conjunction with the accompanying drawings, in which:

FIG. 1 schematically illustrates a data processing device and a key input method of the data processing device according to the related art;

FIG. 2 schematically illustrates a keypad device for a touchscreen device and a key input method of the keypad device for a touchscreen device according to an exemplary embodiment of the invention;

FIG. 3 schematically illustrates the configuration of the keypad device for a touchscreen device according to an exemplary embodiment of the invention;

FIG. 4 schematically illustrates a letter input method using a button to which a plurality of letters are allocated according to an exemplary embodiment of the invention;

FIG. 5 schematically illustrates a method of inputting an intended letter with a single action using a direct input function button when a plurality of letters are allocated to a single button according to an exemplary embodiment of the invention; and

FIG. 6 schematically illustrates a mode designation button and a mode designation operation using the mode designation button according to an exemplary embodiment of the invention.

### MODE FOR INVENTION

The present invention, advantages associated with the operation of the present invention and objects that are realized by the practice of the present invention will be apparent from the accompanying drawings which illustrate exemplary embodiments of the present invention and the detailed description of the present invention which are illustrated in the drawings.

Throughout the specification, it will be understood that, when an element is referred to as “transmitting” data to another element, the element not only can directly transmit the data to another element but also indirectly transmit the data to another element via at least one intervening element.

In contrast, when an element is referred to as “directly transmitting” data to another element, the element can transmit the data to another element without an intervening element.

The present invention will now be described more fully hereinafter with reference to the accompanying drawings, in which exemplary embodiments thereof are shown. Reference should be made to the drawings, in which the same reference numerals are used throughout the different drawings to designate the same or similar components.

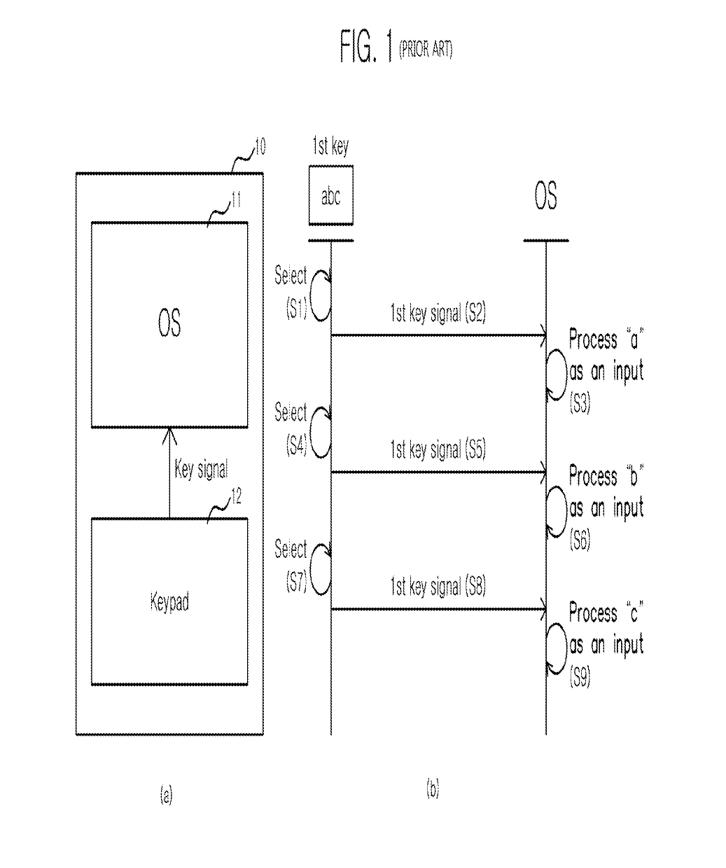

FIG. 1 schematically illustrates a data processing device and a key input method of the data processing device according to the related art.

First, referring to part (a) of FIG. 1, a data processing device 10 of the related art includes an operating system (OS) 11 and a keypad 12. The keypad 12 may be disposed inside the data processing device 10, or may be provided as a keypad (or keyboard) 10 which can be connected to a main body of the data processing device 10. In some implementations, the keypad 12 may be a soft keypad, i.e. a virtual keypad realized by software.

At any case, when a user selects a button (or a key) on the keypad 12 (e.g., by an action of pressing or touching the button with at least a certain level of intensity), the keypad 12 outputs a key signal corresponding to the selected key to the OS 11. The OS 11 subsequently performing input processing on a letter (or a symbol) corresponding to the key signal or performs a control operation corresponding to the key signal (e.g., displacing a cursor or scrolling pages up or down).

In this case, when the keypad 12 is not a full keyboard, a plurality of letters are allocated to a single button. When the button is consecutively selected within a certain time, a plurality of letters can be sequentially input-processed by the OS 11. However, in this case, the keypad 12 included in or connected to the data processing device 10 of the related art also outputs the same key signal. When the same key signal is consecutively input, the OS 11 performs input processing by determining a letter (or a symbol) corresponding to the key signal.

The data processing device 10 of the related art is required to support only the keypad 12 that is designed for and equipped in the data processing device 10 or a standardized keypad, i.e. the keypad 12 of which the OS 11 is already aware. When a button on the known keypad 12 is selected, the OS 11 processes a letter (or a symbol) as an input in a corresponding fashion. Therefore, the keypad 12 of the related art can passively output a preset key signal whenever a specific button is selected, and the OS 11 can determine which letter (or symbol) the output key signal indicates and process the letter (or symbol) as an input.

Such an example is illustrated in part (b) of FIG. 1.

Referring to part (b) of FIG. 1, a plurality of letters, for examples, letters a, b and c, may be allocated to a first key on the keypad 12. When the first key is consecutively selected within a certain time, the letters a, b and c can be sequentially processed as inputs by the data processing device 10.

When the first key is selected first time (S1), the keypad 12 outputs the first key signal to the OS 11 (S2). Since the first key signal is input first time, the OS 11 can subsequently process the letter “a” as an input in response to the first key signal (S3).

Afterwards, the first key may be selected again within a certain time (S4). At this time, the key pad 12 can also output the first key signal to the OS 11 (S5). Since the same key signal as input into the previous letter is received within the certain time, the letter “b” to be input after the letter “a” can be processed as an input (S6).

In addition, even in the case that the first key is selected again within the certain time (S7), the keypad 120 outputs the same first key signal to the OS 11 (S8). Since the same key signal as input into the previous letter is received within the certain time, the letter “c” to be input after the letter “b” can be processed as an input (S9).

In this manner, in the letter input method of the related art, since the OS 11 is already aware of the input sequence of the buttons on the keypad 12 and a plurality letters allocated to each of the buttons, the keypad 12 is required to output only a key signal corresponding to a selected button even in the case that any button is selected. The OS 11 subsequently judges to which letter the current input key signal corresponds based on at what time the current input key signal is input and what the previous key signal was, and subsequently performs letter input processing according to the result of the judgment.

However, in this case, there is a problem in that the OS 11 is required to be always aware of what keypad is used. A combination of letters (or symbols) allocated to the keypad 12 can be used after the combination of letters (or symbols) is previously registered in the OS 11. For this, there is a problem in that software readable by the data processing device 10 must be developed and/or installed according to types of data processing device 10. It is therefore difficult or expensive to provide a universal keypad device as intended in the present invention.

In addition, no combinations of letters used in the keypad are designed such that visually impaired persons can use them or visually unimpaired persons can use them without paying careful attention to the keypad. When the physical keypad or soft keypad of the related art is used, it is difficult to use or learn the combinations of letters.

Therefore, in order to overcome these problems, a keypad device for a touchscreen device (hereinafter, referred to as a “keypad device 100”) according to an exemplary embodiment of the invention can provide an intuitive interface using a reduced number of buttons. In addition, the keypad device 100 itself can maintain and/or manage information on a letter corresponding to an output signal that was output in response to the selection of a previous button and/or information on a time that has elapsed after the selection of the previous button whenever a button is selected, and thus output an output signal corresponding to a letter to be processed as an input whenever a button is selected. While the keypad 12 of the related art outputs the same key signal, the keypad device 100 according to an embodiment of the invention can change an output signal to be output to the touchscreen device, in an adaptive manner based on state information in response to the selection of the previous button. Accordingly, even in the case that the touchscreen device is unaware of a combination of letters of the keypad device 100, a letter corresponding to a received output signal can be processed as an input. It is therefore possible to provide the universal keypad device 100 independent of a type and/or implementation of touchscreen device. In addition, this compatibility allows a user to easily learn to control, for example, a combination of letters or a combination of commands that the keypad device 100 provides.

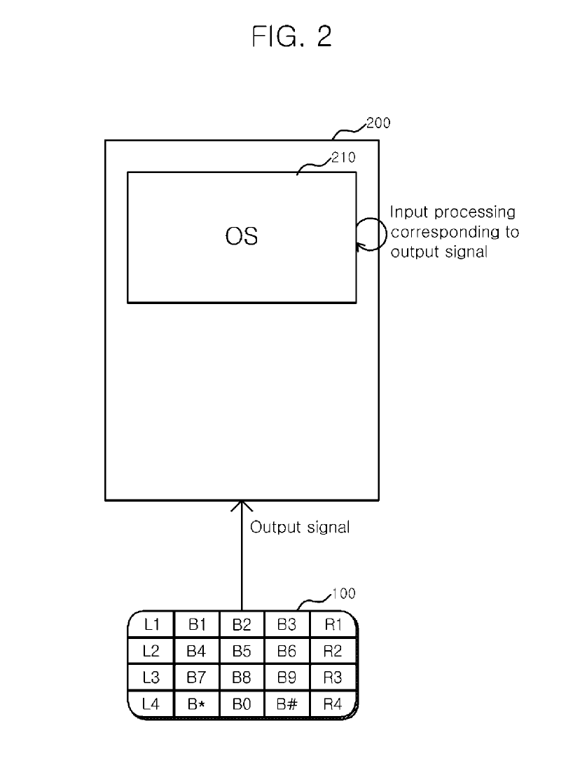

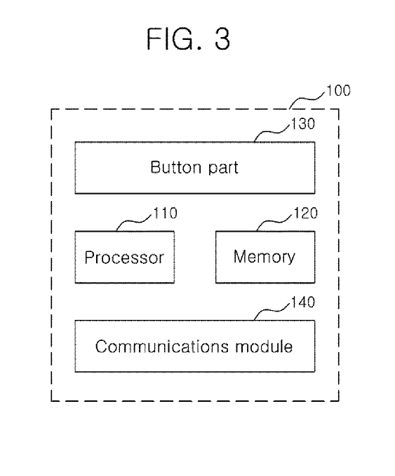

An example of this keypad device 100 is illustrated in FIG. 2 and FIG. 3.

FIG. 2 schematically illustrates a keypad device for a touchscreen device and a key input method of the keypad device for a touchscreen device according to an embodiment of the invention.

In addition, FIG. 3 schematically illustrates the configuration of the keypad device for a touchscreen device according to an embodiment of the invention.

Referring to FIG. 2 and FIG. 3, the keypad device 100 according to an embodiment of the invention can output an output signal corresponding to a letter to be input to a touchscreen device 200 whenever a button is selected. An operating system (OS) 210 of the touchscreen device 200 can subsequently perform input processing on the letter corresponding to the received output signal.

Although the keypad device 100 illustrated in FIG. 2 shows an embodiment in which the buttons of the keypad device 100 are arranged in a 4×5 matrix, the scope of the invention is not limited thereto.

In addition, symbols allocated to the buttons of the keypad device 100 illustrated in FIG. 2 (e.g. B1 to B0, L1 to L4, R1 to R4, B* and B#) are merely provided to indicate the positions of the buttons, but are not intended to indicate letters that are input when the buttons are selected.

In the meantime, as illustrated in FIG. 3, the keypad device 100 includes a processor 110, a memory 120, a button part 130 including a plurality of buttons, and/or a communications module 140.

The processor 110 can control the overall operations of the keypad device 100. In addition, the processor 110 can control the functions and/or resources of the other components (e.g. the memory 120 and/or the communications module 140) included in the keypad device 100.

The plurality of buttons in the button part 130 include letter buttons (e.g. B1 to B0). In addition, since the keypad device 100 is not a full keyboard, each of the letter buttons (B1 to B0) may be allocated with a plurality of letters. The plurality of letters allocated to the letter buttons (e.g. B1 to B0), i.e. the letters and/or the symbols can be combined such that combinations thereof have superior intuition and usability which will be described later.

The memory 120 can store data required for realizing the concept of the invention. In an embodiment, the memory 120 can store state information according to an embodiment of the invention. When a letter button is selected from among the plurality of buttons of the button part 130, the state information may include information on a previous output signal corresponding to a button selected just before the letter button is selected or a letter corresponding to the previous output signal. Specifically, the state information not only includes information on which button was selected just before the letter button is selected (information on the previous button), but also indicates information on a letter to which the output signal in response to the selection of the previous button corresponds.

Therefore, when a button is selected, the processor 110 can select an output signal based on the state information stored in the memory 120, the output signal corresponding to a letter to be processed as an input at the touchscreen device 200. The processor 110 can subsequently output the selected output signal to the touchscreen device 200.

The communications module 140 can selectively output a plurality of output signals corresponding to a plurality of letters allocated to the letter button to the touchscreen device 200. Specifically, when a letter button is consecutively selected, the communications module 140 can output the different output signals corresponding to the plurality of letters allocated to the letter button to the touchscreen device 200. The processor 110 can select which output signal to be output when the letter button is selected. From among the output signals that can be output when the letter button is selected, the output signal selected by the processor 110 (i.e. the selected output signal) can be output to the touchscreen device 200 via the communications module 140.

The communications module 140 can output an output signal to the touchscreen device 200 via wireless/wired communication. In an example, the communications module 140 can perform Bluetooth communication with the touchscreen device 200. However, the present invention is not limited thereto, but a variety of communication protocols can be the communications module 140.

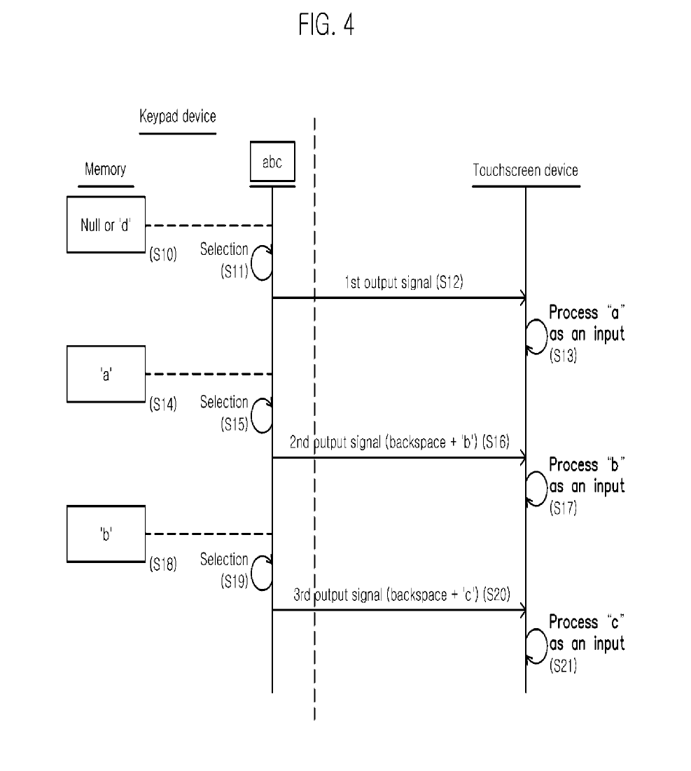

A reference will now be made to a letter input method by the keypad device 100 including the above-described configuration according to an embodiment of the invention in conjunction with FIG. 4.

FIG. 4 schematically illustrates a letter input method using a button to which a plurality of letters are allocated according to an embodiment of the invention.

Referring to FIG. 4, a plurality of letters, for example, letters a, b and c may be allocated to a single letter button on the keypad device 100 according to an embodiment of the invention. When the letter button is consecutively selected within a certain time, the letters a, b and c can be sequentially processed as inputs by a predetermined input sequence by the touchscreen device 200.

For example, the touchscreen device 200 can process the letter a as an input when the letter button is selected once without being selected again within a certain time. In addition, the touchscreen device 200 can process the letter b as an input when the letter button is consecutively selected two times and the letter c as an input when the letter button is consecutively selected three times. In addition, the letters can be sequentially processed as inputs in the sequence of a, b and c.

At this time, when a letter button on the keypad device 100 is selected first time (S11), the processor 110 can check state information stored in the memory 120. The state information stored in the memory 120 can include information on a letter corresponding to an output signal that is output in response to a previous button being selected just before the selection of the letter button (S10). The stored information may include information indicating that no button is selected (e.g. null) just before the selection of the letter button or information indicating an output signal corresponding to a letter (e.g. d) other than those allocated to the letter button is output. In some implementations, when the previous button is not the letter button, information indicating the previous button may be stored in the memory 120, rather than the information on the letter (e.g. d) corresponding to the output signal that is output in response to the selection of the previous button.

The processor 110 can subsequently check the state information stored in the memory 120, and based on the result of the checking, determine that a first output signal to be output in response to the selection of the letter button (S11) is an output signal corresponding to the letter a. The processor 110 can subsequently control the communications module 140 to output the first output signal corresponding to the letter a to touchscreen device 200 (S12). After the first output signal is output, the processor 110 can store information on the letter a corresponding to the first output signal in the memory 120 (S14). The touchscreen device 200 can subsequently receive the first output signal and process the letter a corresponding to the received first output signal as an input (S13).

After the selection of the letter button (S11), when the letter button is selected again within a certain time (S15), the processor 110 can check state information stored in the memory 120. Since the state information includes information on the letter (e.g. a) corresponding to the previous output signal, i.e. the first output signal, the processor 110 can determine to output a second output signal, i.e. an output signal corresponding to the letter b to be input after the letter (e.g. a), to the touchscreen device 200. The second output signal corresponding to the letter b can be subsequently output to the touchscreen device 200 (S16). It is preferable that, in response to the letter button being consecutively input and even in the case that a letter to be finally input is not determined yet, the touchscreen device 200 displays a letter corresponding to a current selection whenever the letter button is selected such that a user can input the letter in an intuitive fashion. Therefore, it is preferable that, when the touchscreen device 200 processed the letter a as an input, the letter a is displayed on a user interface (UI). Afterwards, when the letter button is consecutively selected, it is preferable that the letter b corresponding to the current second output signal is displayed on the touchscreen device 200 instead of the previous letter a that was displayed before.

Therefore, in this case, the processor 110 can output the current second output signal to the touchscreen device 200, in which the current second output signal includes a delete signal with which the previous letter a corresponding to the first output signal, i.e. the previous output signal, is deleted (e.g. the signal corresponding to a backspace) and a signal corresponding to the letter b to be input after the previous letter a from among the plurality of letters a, b and c. For example, the processor 110 can output a plurality of signals corresponding to the backspace and the letter b to the touchscreen device 200. In addition, the processor 110 can store information on the letter b corresponding to the second output signal in the memory 120 (S18).

After the letter button is selected (S15), even in the case that the letter button is selected within a certain time, the above-described process can be performed. Specifically, the processor 110 can determine an output signal to be output based on the state information stored in the memory 120 as a third output signal corresponding to the letter c. The third output signal can be subsequently output to the touchscreen device 200 (S20). The letter c can be subsequently processed as an input by the touchscreen device 200. In addition, the third output signal can include a signal with which the previous letter is deleted and a signal corresponding to the letter c by their sequence.

When FIG. 4 illustrating the concept of the invention is compared with FIG. 1 (b) illustrating the related-art method, the characteristics of the keypad device 100 according to an embodiment of the invention will be apparent.

In this manner, the keypad device 100 according to an embodiment of the invention can output different output signals to the touchscreen device 200 according to circumstances even in the case that the same letter button is selected. In addition, the keypad device 100 can adaptively determine a letter to be input-processed by itself whenever the letter button is selected, and output an output signal corresponding to the adaptively-determined letter to the touchscreen device 200. Accordingly, the touchscreen device 200 is merely required to process the letter corresponding to the received output signal as an input.

In addition, according to the above-described concept, the OS of the touchscreen device 200 is not required to be aware of a combination of keys (e.g. a combination of letters or a combination of symbols) of the keypad device 100. The keypad device 100 on which the method operates can be a universal keypad device independent of the touchscreen device 200.

The keypad device 100 according to an embodiment of the invention can increase portability since it has a reduced number of buttons compared to a full keyboard. However, as mentioned above, there is a problem in that a letter button must be selected several times in order to input a letter (e.g. c) allocated to the letter button.

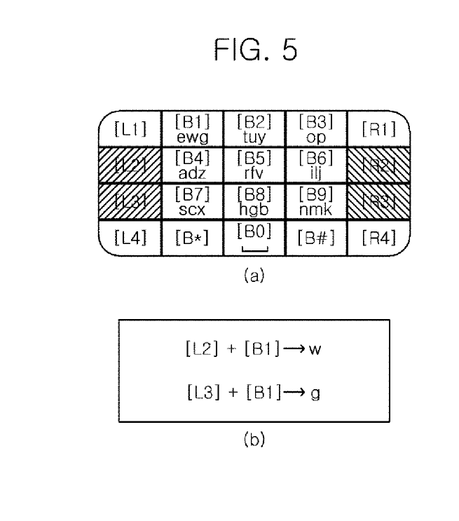

A concept for overcoming this problem will be described with reference to FIG. 5.

FIG. 5 schematically illustrates a method of inputting an intended letter with a single action using a direct input function button when a plurality of letters are allocated to a single button according to an embodiment of the invention.

First, referring to part (a) of FIG. 5, an n (e.g. 3) number of letters (e.g., e, w and q) may be allocated to a single letter button (e.g. B1) from among the plurality of buttons of the keypad device 100. When the user must consecutively select the letter button B1 two times in order to input the letter w, he/she must consecutively select the letter button B1 three times, which is inconvenient.

In order to overcome this inconvenience, the button part 130 in the keypad device 100 can include at least n−1 number (e.g. two) of direct input function buttons. The direct input function buttons can be a combination key to which no letter is not allocated. That is, when one of the direct input function buttons and a letter button are simultaneously selected, an output signal corresponding to a letter or a control signal can be output.

Different numbers of letters may be allocated to the letter buttons on the button part 130. In this case, n may be set as the number of letters (e.g. 3) corresponding to a letter button to which the greatest number of letters are allocated.

In some implementations, the number of the direct input function buttons may be n. However, the n number of direct input function buttons is not necessarily required, since the first letter (e.g. e) of the plurality of letters allocated to the letter button (e.g. B1) can be input directly with one selection.

According to an embodiment, the direct input function buttons may be arranged on an edge column or row of a matrix on which the button part 130 is disposed. For example, as illustrated in FIG. 5, when the button part 130 is arranged in a 4×5 matrix, the direct input function buttons may be arranged on at least one of first and fourth columns or first and fifth rows. Since the direct input function buttons are arranged on the edge column or row in this manner, when the user is holding the keypad device 100, he/she can easily select another button in the state that he/she already selected one of the direct input function buttons.

In addition, the sequence in which the n or n−1 number of direct input function buttons (e.g. L2 and L3 or R2 or R3) are arranged may correspond to the sequence in which the letters from among the n number of letters allocated to a single letter button are directly input by the direct input function buttons (e.g. L2 and L3 or R2 or R3).

For example, the first direct input function button (e.g. L2) can be a button which allows a second letter in the input sequence from among letters allocated to a letter button to be input directly. The second direct input function button (e.g. L3) is arranged adjacent to the first direct input function button (e.g. L2). With the second direct input function button (e.g. L3), a third letter in the input sequence from among letters allocated to a letter button can be input directly.

Therefore, in the case that the n−1 number of direct input function buttons are sequentially arranged to be adjacent to each other and an m^{th} direct input function button (where m is a natural number ranging from 2 to n−1) is a button which allows an (m+1)^{th} letter from among a plurality of letters allocated to a letter button to be input directly, an (m+1)^{th} direct input function button may be a button that allows an (m+2)^{th} letter from among the plurality of letters allocated to the letter button to be input directly. Of course, in the case that the n number of direct input functions buttons are provided, when a first direct input function button is selected from among the direct input functions buttons which are sequentially arranged and a letter button is selected, a first letter from among a plurality of letters allocated to the letter button can be input directly. When a second direct input function is selected, a second letter can be input directly.

When the plurality of direct input function buttons are sequentially arranged and the sequence of letters to be input directly is previously determined by the sequence of the arrangement, the user can intuitively recognize the sequence of the letters to be input directly according to the positions of the direct input function buttons.

As illustrated in part (b) of FIG. 5, when the letter button B1 is selected in the state that the first direct input function button (e.g. L2) is selected, the processor 110 can control an output signal corresponding to the letter w to be output to the touchscreen device 200. In addition, when the letter button B1 is selected in the state that the second direct input function (e.g. L3) is selected, the processor 110 can control an output signal corresponding to the letter q to be output to the touchscreen device 200.

In addition, the combination of letters allocated to the letter buttons, as illustrated in FIG. 5, can be a combination that is determined based on user convenience. In addition, although not illustrated in FIG. 5, the letter buttons can be implemented such that the letter buttons can input different types of letters according to modes. For example, when the keypad device 100 is in an input mode, the combination of letters illustrated in FIG. 5 may be a combination of letters to be input. When the keypad device 100 is in a number input mode, a combination of numbers allocated to each letter button may be a combination of letters to be input. In addition, in a symbol input mode, symbols can be input according to a combination of symbols allocated to each letter button.

The keypad device 100 according to an embodiment of the invention discloses an example of a combination of English letters and/or a combination of symbols that are frequently used.

First, describing the combination of symbols, all symbols on a computer keyboard may be allocated to 12 [B] buttons, i.e. letter buttons, at the center.

Symbols may be disposed on corresponding number buttons based on their similarities to numbers such that the buttons to which the symbols are allocated can be easily remembered. For example, symbols “!” and “?” may be recognized as being similar to numbers 1 and 2, symbols “′” and “″” may be recognized as being similar to numbers 4 and 5, and “@” may be recognized as being similar to a number 6. In addition, symbols “<” and “>” may be may be recognized as being similar to numbers 4 and 7, symbols “(” and “)” may be recognized as being similar to numbers 6 and 9, and symbols “;,” “:,” “,” and “.” may be recognized as being similar to numbers 7, 8, 9 an 0. Furthermore, symbols “/” and “\” may be may be recognized as being similar to 1, a symbol “˜” may be may be recognized as being similar to 2, “[” and “]” may be may be recognized as being similar to the symbols “<” and “>,” symbols “{” and “}” may be recognized as being similar to the symbols “(” and “),” symbols “&” and “$” may be recognized as being similar to 8, a symbol “=” may be recognized as being similar to the symbol ““,” and symbols “̂” and “%” may be recognized as being similar to a symbol “*.” In addition, most similar forms from among the remaining symbols are as follows: the symbol “ ” may be recognized as being similar to 5, the symbol “′” may be recognized as being similar to 2, and the symbols “−,” “+,” “,” and “|” may be recognized as being similar to 3. In addition, the symbol “*” is present in [B*], and the symbol “#” is present in [B#]. Therefore, combinations of symbols allocated to the 12 letter buttons based on these criteria of recognition may be as follows:

[B1 ! / \] [B2 ? ′] [B3 −+|]

[B4 ′<[ ] [B5 ″=_] [B6 @ ({]

[B7; >]] [B8: & $] [B9, )}]

[B* ̂ * %] [B0 .] [B# #]

When the button [B1] is allocated with the symbols “!,” “/,” and “\”, the other buttons may be allocated with the other symbols in the same fashion.

In addition, an example of a combination of English letters may be determined as follows:

A small QWERTY alphabet arrangement may be an arrangement in which 26 alphabet letters are allocated to 9 buttons [B1] to [B9]. 2 or 3 alphabet letters may be arranged on each button according to the well-known QWERTY arrangement of a computer keyboard. It is therefore possible to easily remember the buttons to which the letters are allocated and locate the letters in an intuitive fashion. In addition, in each button, a frequently-used letter is arranged on the front based on the frequency of use of letters, such that the letters can be input by pressing the button less times.

Referring to the small QWERTY arrangement according to the QWERTY arrangement of the computer keyboard, the letters q, w and e are located on the top left button [B1], the letters t, y and u are located on the top button [B2], and the letters o and p are located on the top right button [B3]. In addition, the letters a and d are located on the left button [B4], the letter f is located on the center button [B5], the letters j and 1 are located on the right button [B6], the letters x and c are located on the bottom left button [B7], the letter b is located on the bottom button [B8], and the letters n and m are located on the bottom right button [B9]. From among the 26 alphabet letters, these 18 letters may be located at the relatively same positions as in the QWERTY arrangement, and the remaining 8 letters may be located above or below the QWERTY positions by one row. The letters g and h located at the center in the QWERTY arrangement may be located on the button [B8] that is one row below, the letter i located at the top right may be located on the button [B6] that is one row below, and the letter k located at the right may be located on the button [B9] that is one row below. The letter r at the top may be located on the button [B5] that is one row below, and the letter s at the top may be located on the button [B7] that is one row below. The letter v at the bottom may be located on the button [B5] that is one row above, and the letter z at the left may be located on the button [B4] that is one row below.

According to statistics, 9 letters, including a, e, h, i, n, o, r, s and t, are most frequently used, and the frequency of use thereof is known to be about 70% of the total letters. The next most frequent 9 letters are c, d, f, g, l, m, p, u and w, and the frequency of use thereof is known to be about 25%. The remaining 8 letters are b, j, k, q, v, x, y and z, and the frequency of use thereof is known to be about 5%.

When the 26 alphabet letters are allocated to the 9 buttons [B1] to [B9], the most frequently-used 9 letters are placed at the first positions of the 9 buttons, the next most frequently-used 9 letters are placed at the second positions of the 9 buttons, and the least frequently-used 8 letters are placed at the third positions of the 9 buttons. This can consequently make a combination of letters in which English letters are input by pressing the buttons less times. For reference, buttons are pressed 2.14 times in average in order to input one letter using the ABC combination of letters which is generally used in a small keypad of the related art and in which letters are arranged by the alphabetic sequence. In contrast, when a simulation was made using the small QWERTY arrangement according to an embodiment of the invention, buttons were pressed 1.35 times in average.

Combinations of English letters based on this concept (also referred to as the small QWERTY arrangement) according to an embodiment of the invention can be arranged as follows:

[B1 e w q] [B2 t u y] [B3 o p]

[B4 a d z] [B5 r f v] [B6 i l j]

[B7 s c x] [B8 h g b] [B9 n m k]

[B0 space] is identical to [B# space], and a space may be allocated thereto.

In addition, as described above, the keypad device 100 can provide a variety of input modes. For example, input modes that the keypad device 100 supports may include a navigation mode, a first language (e.g. English) input mode, a second language (e.g. Korean) input mode, a number input mode, a symbol input mode, etc.

The navigation mode may be a mode able to control, for example, search for, select, activate or inactivate, items included in an application operating on the touchscreen device 200, items (or icons) included on the background of the touchscreen device 200, or the like.

For example, [B4] may be a button for selecting a previous item, and [B6] may be a button form selecting a next item. [B1] may be used to select the first item on the current screen, and [B7] may be used to select the last item on the screen.

In this manner, the keypad device 100 can provide a variety of input modes.

Assuming only the navigation mode, the first language (e.g. English) input mode, the second language (e.g. Korean) input mode, the number input mode and the symbol input mode are provided by way of example, the memory 120 can further store information on the current mode from among the plurality of modes that the keypad device provides. That is, the information on the current mode can be stored as being included in the state information.

In addition, the button part 130 may include a mode switch button with which the current mode is switched into another mode. The mode switch button can sequentially switch the above-described modes, for example, by a predetermined sequence. When the modes are sequentially switched by the predetermined sequence in this fashion, the current mode may not be correctly recognized by a visually impaired person. In addition, a visually unimpaired person may not correctly remember the current mode when he/she is not looking at the current mode. In this case, the user cannot correctly make a desired input, which is problematic.

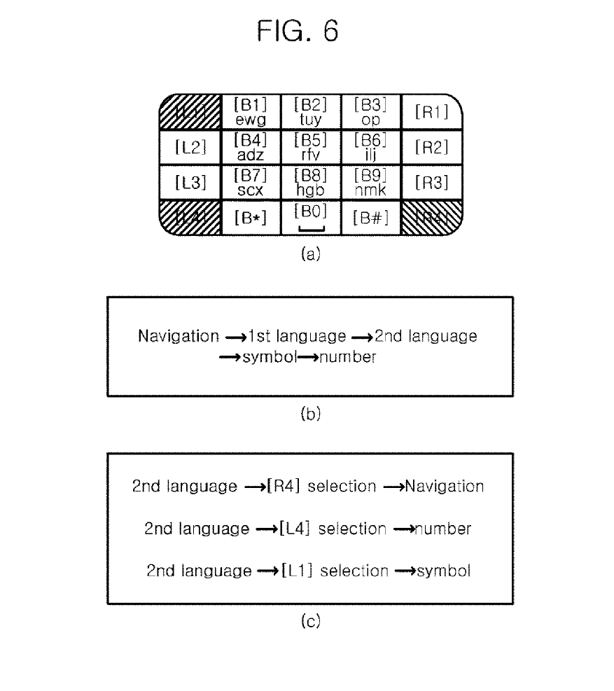

A concept for overcoming this problem is illustrated in FIG. 6.

FIG. 6 schematically illustrates a mode designation button and a mode designation operation using the mode designation button according to an exemplary embodiment of the invention.

Referring to part (a) of FIG. 6, the button part 130 of the keypad device 100 can include mode designation buttons (e.g. L4 or R4) according to the concept of the invention. The mode designation buttons (e.g. L4 or R4) may be buttons with which the keypad device 100 can always enter designated modes corresponding to the mode designation buttons (e.g. L4 or R4), regardless of the current mode of the keypad device 100 stored in the memory 120 or a predetermined mode switching sequence when the mode switch button (e.g. L1) is selected.

In addition, when the mode switch button (e.g. L1) is selected, the keypad device 100 can perform a mode switching by a predetermined sequence (e.g. navigation mode→first language input mode→second language input mode→symbol input mode→number input mode), as shown in part (b) of FIG. 6.

For example, in the state that the current mode is the second language input mode, as illustrated part (c) of FIG. 6, when the mode designation mode L4 is selected, the processor 110 can switch the keypad device 100 to the number input mode regardless of the current mode of the keypad device 100. For example, when the mode designation button R4 is selected, the processor 110 can switch the keypad device 100 to the navigation mode regardless of the current mode of the keypad device 100.

In addition, when the mode switch button L1 is selected, the current mode can be switched to the symbol input mode by the predetermined sequence.

When the mode designation buttons (e.g. L4 or R4) for always entering to predetermined modes regardless of the current mode are provided in this manner, at any time, the user can enter the current mode to one mode of which he/she is aware by selecting one of the mode designation buttons (e.g. L4 or R4). Therefore, it is possible to prevent a wrong mode from being input by mistake.

At least one of the mode designation buttons (e.g. L4 or R4) may be provided. A frequently-used mode (e.g. the navigation mode) can be preset such that it corresponds to one of the mode designation button (e.g. L4 or R4).

In addition, at least one of the mode designation buttons (e.g. L4 or R4) can be arranged on at least one corner of the matrix on which the button part 130 of the keypad device 100 is disposed. For example, buttons (e.g. L1, L4, R1 or R4) corresponding to the corners of the 4×5 matrix can be allocated as the mode designation buttons. When the buttons positioned at the corners are used as the mode designation buttons, it is possible to easily recognize the mode to which the keypad device 100 is to switch even in the case that the current mode is not recognized. It is also possible to reduce the possibility that the mode designation buttons may be erroneously selected.

The certain embodiments of the keypad device for a touchscreen device and the method of providing the same according to the present invention can be embodied as computer readable codes that are stored in a computer readable recording medium. The computer readable recording medium includes all sorts of record devices in which data that are readable by a computer system are stored. Examples of the computer readable recording medium include read only memory (ROM), random access memory (RAM), compact disc read only memory (CD-ROM), a magnetic tape, a hard disc, a floppy disc, an optical data storage device and the like. Further, the recording medium may be implemented in the form of a carrier wave (e.g. Internet transmission). In addition, the computer readable recording medium may be distributed to computer systems on the network, in which the computer readable codes are stored and executed in a decentralized fashion. In addition, functional programs, codes and code segments for embodying the present invention can be easily construed by programmers having ordinary skill in the art to which the present invention pertains.

While the present invention has been described with reference to the certain exemplary embodiments shown in the drawings, it will be understood by a person skilled in the art that various modifications and equivalent other embodiments may be made therefrom. Therefore, the true scope of the present invention shall be defined by the concept of the appended claims.

### INDUSTRIAL APPLICABILITY

The present invention is applicable as an input device of a touchscreen device.

1. A keypad device provided separately from a touchscreen device to control the touchscreen device, comprising:
a plurality of buttons;
a memory;
a processor; and
a communications module, wherein, when a letter button to which the plurality of letters are allocated is selected from among the plurality of buttons, the communications module outputs an output signal selected from among a plurality of output signals to the touchscreen device, the plurality of output signals respectively corresponding to a plurality of letters,
wherein the processor selects the selected output signal from among plurality of output signals based on state information stored in the memory and controls the selected output signal to be output,
wherein the state information includes information on a previous output signal that is output in response to a previous button being selected just before the letter button is selected.

2. (canceled)

3. The keypad device according to claim 1, wherein, when the previous letter corresponding to the previous output signal is allocated to the letter button, the processor controls the selected output signal to be output, the selected output signal including a delete signal with which the previous letter is deleted and a signal corresponding to a letter from among the plurality of letters that is to be input after the previous letter.

4. (canceled)

5. (canceled)

6. The keypad device according to claim 1,
wherein the state information further includes information on a current mode from among a plurality of modes that the keypad device provides, and
wherein the plurality of buttons includes:
at least one mode switch button which switches the keypad device from a current mode to another mode; and
at least one mode designation button which switches the keypad device to a predetermined mode regardless of the current mode when selected.

7. The keypad device according to claim 6, wherein the plurality of buttons are arranged in an a×b matrix, where each of the a and the b is a natural number equal to or greater than 2, and all or part of the at least one mode designation button is arranged at a position corresponding to a corner of the a×b matrix.

8. (canceled)

9. A keypad device provided separately from a touchscreen device to control the touchscreen device, comprising:
a plurality of buttons;
a memory;
a processor; and
a communications module, wherein the communications module outputs an output signal corresponding to a button selected from among the plurality of buttons to the touchscreen device,
wherein the memory stores information on a current mode among plurality of input modes of the keypad device,
wherein the plurality of buttons includes:
at least one mode switch button which switches the keypad device from a current mode to another mode; and
at least one mode designation button which switches the keypad device to a predetermined mode regardless of the current mode when selected.

10. A method of providing a keypad device separately from a touchscreen device to control the touchscreen device, the method comprising:
being selected a letter button to which a plurality of letters are allocated from among a plurality of buttons on the keypad device;
selecting, at the keypad device, an output signal from among a plurality of output signals respectively corresponding to the plurality of letters, based on state information stored in the keypad device; and
outputting, at the keypad device, the selected output signal to the touchscreen device,
wherein the state information includes information on a previous output signal that is output in response to a previous button being selected just before the letter button is selected.

11. The method according to claim 10, wherein the selected output signal includes a delete signal with which a previous letter corresponding to previous output signal is deleted and a signal corresponding to a letter from among the plurality of letters that is to be input after the previous letter.

12. (canceled)

13. The method according to claim 10, comprising:
being selected a mode designation button from among the plurality of buttons on the keypad device;
switching, at the keypad device, to a predetermined mode among plurality modes of the keypad device regardless of a current mode of the keypad device.

14. (canceled)

15. A method of providing a keypad device separately from a touchscreen device to control the touchscreen device, the method comprising:
storing, at the keypad device, information on a current mode among plurality modes of the keypad device; and
switching, at the keypad device, from the current mode to another mode by a predetermined sequence when a mode switch button is selected and to a predetermined mode regardless of the current mode when a mode designation button is selected.

16. A non-transitory computer readable recording medium in which a program for carrying out the method as claimed in claim 10 is recorded.

17. A non-transitory computer readable recording medium in which a program for carrying out the method as claimed in claim 15 is recorded.
